(19) United States
(12) Patent Application Publication
(10) Pub. No.: US 2011/0119716 A1
(43) Pub. Date: May 19, 2011

(54) System and Method for Video Distribution Management with Mobile Services

(75) Inventor: Marquis R. Coleman, SR., Detroit, MI (US)

(73) Assignee: MIST TECHNOLOGY HOLDINGS, INC., Detroit, MI (US)

(21) Appl. No.: 13/005,871

(22) Filed: Jan. 13, 2011

Related U.S. Application Data
(63) Continuation-in-part of application No. 12/402,595, filed on Mar. 12, 2009.
(60) Provisional application No. 61/294,963, filed on Jan. 14, 2010.

(51) Int. Cl. H04N 7/16

(52) U.S. Cl. 725/62

(57) ABSTRACT

Systems and methods for managing video distribution to display devices including mobile devices capture video from one or more cameras and apply a selected compression strategy suitable to broadcast video over a computer network and cellular network to at least one mobile device only when requested by a user to improve security and reduce required bandwidth and usage. The system and method may include controlling broadcast bandwidth by dynamically changing the selected compression strategy or algorithm to facilitate management of the video stream and adapt to changing network conditions. In one embodiment, the system and method include dynamically modifying video image properties of captured video frames to generate video data packets of a size suitable for transmission over a low bit-rate channel to a hand-held device for viewing.

### CROSS-REFERENCE TO RELATED APPLICATIONS

This application claims priority to U.S. Provisional Pat. App. Ser. No. 61/294,963 filed Jan. 14, 2010, and is a continuation-in-part of commonly owned and co-pending U.S. patent application Ser. No. 12/402,595 filed Mar. 12, 2009, the disclosures of which are hereby incorporated by reference in their entirety.

### BACKGROUND

1. Technical Field

Embodiments of the present disclosure relate to systems and methods for managing video delivered to a mobile device.

2. Background Art

Various strategies have been developed to transmit video information over transmission channels of different bandwidths and reliability. System design parameters are often application specific and may be selected based on a number of considerations, such as the desired size and quality of the received video image (including resolution, frame rate, color depth, etc.), the latency between transmitting and receiving the video, the efficiency and reliability of the transmission network(s), and the processing capabilities of the transmitting and receiving devices, for example. Transmission of live broadcasts or near real-time video information of acceptable quality is particularly challenging over wireless networks, such as cellular networks, due to the relatively low bandwidth and low integrity transmission, i.e. lost or dropped data packets. In addition, hand-held devices, such as cell phones, PDAs, and various other hand-held computing/communication devices may have limited processing capabilities and proprietary operating systems and applications. Time-insensitive video streams that are significantly time-delayed or previously stored allow sufficient processing prior to transmission to facilitate sending of the video over such networks using appropriate coding and compression strategies. These applications often do not actually stream the video, but allow for a complete segment of video data to be transmitted to the receiving device prior to processing and playback by the device. As such, these applications may not be appropriate for live broadcasts or time-sensitive video information, such as used in security and surveillance applications, for example.

Existing video surveillance systems may stream video over a network to one or more video display devices, including mobile devices. The video is generally broadcast continually for receipt by these devices with associated bandwidth demands, which may be undesirable or unsuitable for limited bandwidth applications, such as distribution over cellular networks, for example. Similarly, systems designed for video distribution to desktop and laptop computers may use various standard compression/decompression algorithms (CODECS) that may not be suitable for use with mobile devices having limited bandwidth, less memory and persistent storage, reduced processing capability, etc. Custom designed video surveillance and distribution systems may include both types of display devices with associated complexities related to managing devices having different operating systems and other capabilities.

### SUMMARY

Systems and methods for managing video distribution to display devices including mobile devices capture video from one or more cameras and apply a selected compression strategy suitable to broadcast video over a computer network and cellular network to at least one mobile device only when requested by a user to improve security and reduce required bandwidth and usage. The system and method may include controlling broadcast bandwidth by dynamically changing the selected compression strategy or algorithm to facilitate management of the video stream and adapt to changing network conditions. In one embodiment, the system and method include dynamically modifying video image properties of captured video frames to generate video data packets of a size suitable for transmission over a low bit-rate channel to a hand-held device for viewing. The systems and methods may dynamically and automatically control image properties via a hardware capture card device driver to produce a video data packet of a desired maximum data size. Various embodiments include a web-based management system providing a central management console for distributing, configuring, and monitoring streaming video and may include distribution of one or more client applications for various types of display devices including mobile devices.

Embodiments of the present disclosure include a method for streaming video over a cellular network to a hand-held device in response to a request for streaming video from the hand-held device. The method may include determining that the hand-held device is authorized to receive requested streaming video prior to initiating video streaming. Once initiated, the method may include transforming output from a camera to a first color palette, adjusting each of a plurality of image properties until a captured video frame data size is below a first threshold associated with cellular network bandwidth, converting the captured video frame data to a bitmapped image format using a lossless compression algorithm to generate a first compressed frame in a format native to the hand-held device, compressing or coding the first compressed frame using at least a second lossless compression algorithm to generated a compressed packet for transmission; and transmitting the compressed packet over a wireless network to the hand-held device for display on the hand-held device. In one embodiment the video data is first compressed by converting to at least one PNG format before being compressed by an arithmetic coding process. The method may include various additional data manipulation to enhance compression, such as combining multiple frames into a single frame before compression and/or determining differences between frames and compressing and transmitting only the differences with the complete frames rendered by the display device after decompression.

Embodiments may also include a system for streaming video over a cellular network to a hand-held computing device with a display screen where the system includes at least one video source and a server having a video capture card in communication with the at least one video source. The server includes a video capture card device driver and software that controls the device driver to automatically adjust each of a plurality of image properties until a captured video frame data size is below a first threshold associated with currently available bandwidth of the cellular network. The server converts captured video frames to a bitmapped image format using a lossless compression algorithm to generate compressed video frames and then further compresses the compressed video frames using a second lossless compression algorithm to generate compressed packets for transmission. The compressed packets are streamed over the cellular network to the hand held computing device for sequential display on the display screen. Compressed packets may be streamed via the internet to a cellular network service provider for wireless transmission to the hand-held computing device. In one embodiment, video streaming is initiated and/or controlled in response to an authenticated request from a hand-held computing device such as a cellular telephone, PDA, or similar device. The server may interface with an alert/alarm system and send a message to the hand-held device in response to a triggering event to provide video surveillance via the hand-held device.

The present disclosure includes embodiments having various advantages. For example, embodiments according to the present disclosure provide a web portal for centralized management and distribution of streaming video to various display devices including mobile devices. Internet access to a video distribution and management server facilitates registration, downloading, installation, and set-up/configuration of client application software in addition to configuration, management, and reporting associated server software for authorized users. Centralized management and distribution may also provide more convenient business management and facilitates implementations that support the Software as a Service (SAAS) business model. Various embodiments according to the present disclosure facilitate integration of commercially available components to provide video capture and compression with customized embedded streaming controls based on standard video streaming protocols to provide a cost effective wireless video surveillance system allowing users to view live streaming video on a handheld device.

Various embodiments according to the present disclosure combine or cascade various compression, encoding/decoding, and data reduction strategies to generate a lightweight or lower bandwidth stream of data packets representing video information for transmission to a portable hand-held device over a relatively low bandwidth/bit-rate, and generally unreliable network, such as a cellular network, for example. The data packets received by the mobile device are manipulated in near real-time to produce a recognizable video stream on the mobile device.

Embodiments of the present disclosure may include various security features so that only authorized users may initiate, control, and view a selected video stream. A client/server architecture employing a hardened server with a minimal operating system allows the server to be installed on the public side of a network firewall, or in a firewall demilitarized zone, if desired. To enhance security of the video stream, video data from one or more cameras may be captured and processed or packetized for transmission only when requested by an authorized mobile device, with authorized mobile devices determined by an authentication process that may require a valid mobile device ID code in addition to a PIN or password entered by a user to protect against unauthorized access to the video stream if the mobile device is lost or stolen. Once authenticated, a mobile user can select from available video streams and may have the ability to remotely control one or more video sources. A single server may process data from multiple cameras providing near real-time video streaming to multiple users substantially simultaneously.

Various embodiments of the present disclosure transmit packetized video data using streaming technology native to the mobile devices for display of still images, i.e. developed specifically for mobile devices to facilitate viewing of full motion video over a low bit-rate network, i.e. at less than modem speeds, such as a cellular network. In addition, systems and methods of the present disclosure may utilize a client application based on video player technology rather than web page still image display technology to reduce transmission bandwidth and processing requirements of the mobile device.

Embodiments of the present disclosure may be easily integrated into existing video surveillance or security applications interfacing with access control, intrusion detection, security, and automation systems, for example. Alerts, such as text messages, emails, or other information may be transmitted to mobile users in response to a security trigger being activated at a monitored site.

The above advantages and other advantages and features will be readily apparent from the following detailed description of the preferred embodiments when taken in connection with the accompanying drawings.

### BRIEF DESCRIPTION OF THE DRAWINGS

Various features of the embodiments described herein are explicitly described and/or illustrated. However, various other features of the embodiments that may not be explicitly described or illustrated will be apparent to one of ordinary skill in the art. The various embodiments may be best understood by referring to the following detailed description in conjunction with the accompanying drawings, in which:

FIG. 1 is a block diagram illustrating operation of a system or method for streaming video to a hand-held portable device according to various embodiments of the present disclosure;

FIG. 2 is a block diagram or flow chart illustrating operation of one embodiment for packetizing video data for transmission over a low bit-rate channel or network, such as a cellular network, according to the present disclosure;

FIG. 3 illustrates a graphical user interface for manually controlling image properties or attributes that may be automatically adjusted to reduce packet size of captured video frames according to embodiments of the present disclosure;

FIG. 4 illustrates a computer readable storage medium for storing software that may include various functions for streaming video to a hand-held device according to embodiments of the present disclosure;

FIG. 5 provides a more detailed flow chart illustrating operation of a system or method for streaming video performed by a video server using data reduction, coding, and compression strategies according to embodiments of the present disclosure;

FIG. 6 is a block diagram illustrating operation of a method for displaying video streamed over a wireless network on a hand-held computing device according to embodiments of the present invention;

FIG. 7 is a block diagram illustrating a representative system architecture for a video distribution and management system according to various embodiments of the present disclosure;

FIG. 8 is a block diagram illustrating operation of a system or method for video distribution and management according to various embodiments of the present disclosure;

FIG. 9 is a block diagram illustrating representative data flow of a system or method for video distribution and management according to various embodiments of the present disclosure;

FIG. 10 is a state machine diagram illustrating operation of a representative video streaming control in a system or method for video distribution and management according to various embodiments of the present disclosure;

FIG. 11 is a state machine diagram illustrating operation of a representative configuration update function in a system or method for video distribution and management according to various embodiments of the present disclosure;

FIGS. 12A-12C illustrate representative user interfaces for a system or method for video distribution and management according to various embodiments of the present disclosure;

FIG. 13 illustrates a representative web interface for managing configuration settings of a video distribution and management system or method according to various embodiments of the present disclosure; and

FIG. 14 is a flowchart or block diagram illustrating operation of a system or method for video distribution and management according to various embodiments of the present disclosure.

### DETAILED DESCRIPTION OF THE EMBODIMENT(S)

As those of ordinary skill in the art will understand, various features of the embodiments illustrated and described with reference to any one of the Figures may be combined with features illustrated in one or more other Figures to produce embodiments that are not explicitly illustrated or described. The combinations of features illustrated provide representative embodiments for typical applications. However, various combinations and modifications of the features consistent with the teachings of the present disclosure may be desired for particular applications or implementations. The representative embodiments described relate generally to video distribution and management including streaming of video data over a narrow bandwidth and/or low bit-rate channel to a hand-held mobile device, such as a cell phone or PDA, to provide near real-time viewing of time-sensitive video information, such as a live broadcast or video surveillance, for example. However, the teachings of the present disclosure may also be used in various other types of applications that may benefit from video distribution and management including downloading, installing, and configuring mobile device applications as well as compressing and encoding of data for transmission over a low bandwidth channel to facilitate near real time reconstruction on a hand-held device, for example.

Various Figures include block diagrams and/or flow charts to illustrate operation of a system or method for video distribution and management of streaming video according to various embodiments of the present disclosure. Such illustrations generally represent strategies that may be implemented by control logic and/or program code using software and/or hardware to accomplish the functions illustrated and may include various ancillary functions well known by those of ordinary skill in the art. While specific representative implementations may be described for one or more embodiments, this disclosure is independent of the particular hardware or software described. The diagrams may represent any of a number of known processing strategies such as event-driven, interrupt-driven, multi-tasking, multi-threading, and the like performed by one or more processors deployed in integrated or discrete hardware. As such, various functions illustrated may be performed in the sequence illustrated, in parallel, or in some cases omitted Likewise, the order of processing is not necessarily required to achieve the features and advantages of the disclosure, but is provided for ease of illustration and description. The control logic may be embodied in a computer readable medium, such as a hard disk, CD ROM, PROM, EPROM, flash, SDRAM, etc. and may be implemented by program code or software executed by a microprocessor. Of course, various aspects of the control logic may also be implemented by dedicated hardware that may include embedded special-purpose processors and/or electronics consistent with the teachings of the present disclosure.

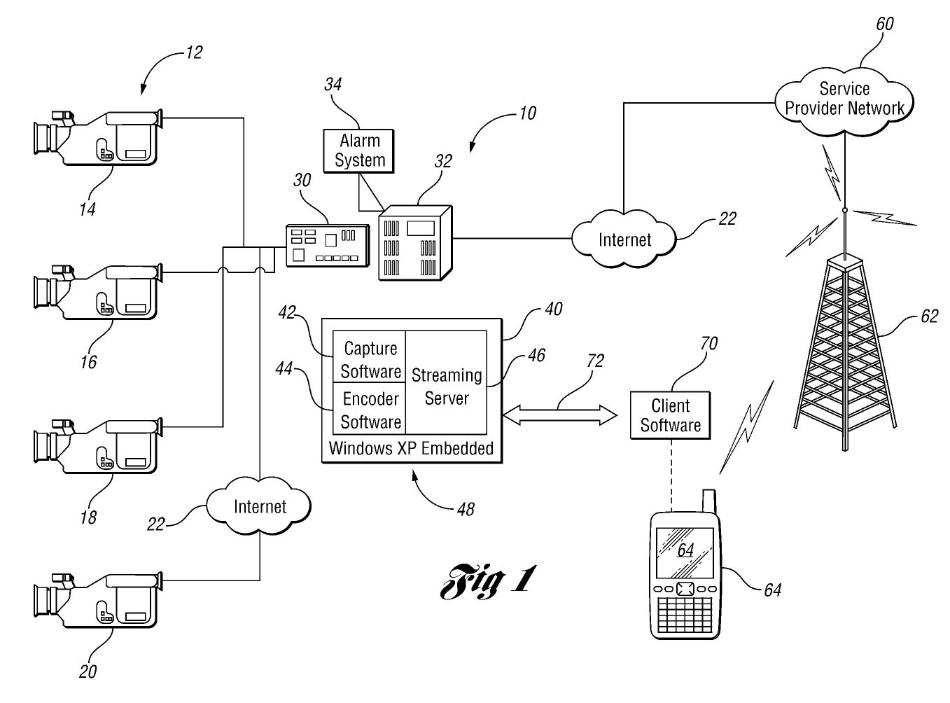

FIG. 1 is a block diagram illustrating operation of a system or method for streaming video to a hand-held device according to one embodiment of the present disclosure. System 10 includes at least one video source 12. In the illustrated embodiment, video source 12 includes cameras 14, 16, 18, directly connected to video capture card 30 of server 32, while camera 20 may be indirectly connected to video capture card 30 over a wired or wireless local-area or wide-area network, such as the Internet 22, for example. Various types of digital or analog cameras may be used as a video source 12 including conventional closed-circuit (CCTV) cameras or web cams connected directly via a BNC, coax, or USB cable, for example. Cameras connected via wired or wireless networks may communicate using any common network protocol, such as TCP/IP, for example. Cameras provide analog or digital video signals in one or more standard formats, such as RGB or YUYV to video capture card 30 installed in server computer 32. In one embodiment, raw video data is captured via video capture card 30 contained in a PCI slot of the server computer with capture card 30 supporting up to 16 cameras. Server computer 32 may support multiple video capture cards depending on the available processor(s) and memory and the required processing time to achieve a desired low latency to provide near real-time streaming video to multiple hand-held mobile devices simultaneously. As those of ordinary skill in the art will appreciate, different types of video sources may require corresponding video capture cards, or the capture card may be eliminated for digital video sources capable of providing video data in a suitable format for subsequent processing Likewise, the number of video sources 12 or video cards 30 will generally be limited by the processing capabilities of server computer 32 because of the processor intensive compression and coding strategies that may be used to provide near real-time video streaming.

Server computer 32 may include commercially available hardware and software in addition to software and/or hardware used to implement the video streaming, distribution, management, configuration, and related functions described herein and represented generally by reference numeral 40. For example, in one embodiment, server computer 32 is a wall mount or rack mount computer having a dual-core Intel Pentium4® processor with 512 MB to 4 GB of RAM, a 1 GB flash drive, USB/Ethernet/Serial ports, at least one video capture card 30 and associated device driver and/or application software 42 corresponding to the number/type of video source(s) 12, an optional audio card/speakers (not shown), and an optional video card/monitor (not shown). As described in greater detail below, a representative embodiment of the encoder software 44 has been designed to run on a Win32 operating system, such as Windows 98 SE®, Windows ME®, Windows 2000®, or Windows XP® with the streaming server software 46 running on Windows 2003 Server®, Windows 2000® Workstation or Server, and Windows XP®. As those of ordinary skill in the art will appreciate, server 32 may utilize a hardened (more secure and less vulnerable to hacking attacks), minimal operating system allowing server 32 to be installed on the public side of a network firewall or in the firewall demilitarized zone (DMZ) without additional protections. In one embodiment, server computer 32 has Windows XP Embedded® as its operating system 48. Of course, the video streaming system and method of the present disclosure may be ported to various other hardware/software platforms depending upon the particular application and implementation as the teachings of the present disclosure are generally independent of the selected platform.

In a representative security or surveillance application as illustrated in FIG. 1, server 32 may also be connected to an alarm system 34 via an appropriate data acquisition or ADC card. In one embodiment, a data acquisition device connects to server computer 32 through a serial port and connects to alarm system 34 through a low-voltage copper pair at an appropriate point where a voltage exceeding a predetermined threshold would indicate an alarm or alert triggering condition. For example, the data acquisition device may be connected to the alarm system signal horn so that alarm system 34 triggers server 32 via the data acquisition device when the alarm system signal horn is activated. Of course, an opposite polarity signal or signal level below a corresponding threshold could be used as a triggering event to provide a signal when power is lost or the signal wire is broken or cut, for example. Use of a data acquisition device, ADC card, or similar device facilitates integration of the video streaming/surveillance functions with any existing security system. Various other alarm system interfaces may be provided to existing access control, intrusion detection, security and/or automation systems with corresponding triggering/alert signals supplied to server 32 with each alert or triggering signal associated with one or more video sources 12 so that an authorized remote user can be alerted based on a triggering condition and receive associated near real-time streaming video on a portable hand-held device 64 as described in greater detail below.

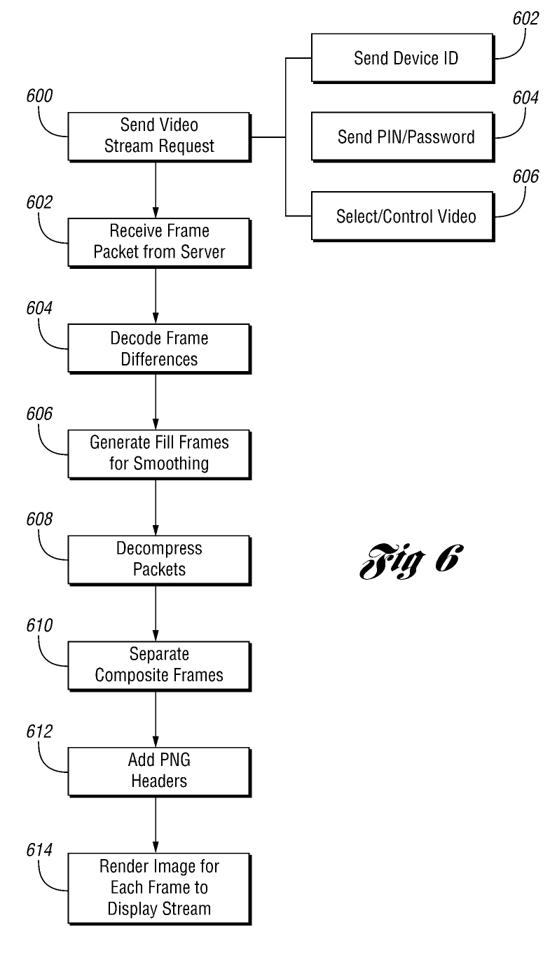

Server computer 32 is connected to a high bandwidth local-area or wide-area network, such as the Internet 22, via an always-on connection, such as DSL, cable, T1, or ISDN connection, for example. Server computer 32 provides one or more requested video streams to a cellular network service provider 60 for wireless transmission via cell tower 62 to a mobile hand-held computing device 64, such as a cell phone or PDA, for example. Hand-held device 64 includes client software 70 that executes an authentication process to establish a logical connection 72 with server 32 to receive and display streaming video on an associated display 66. Hand-held computing device 64 may be implemented by a Pocket PC®, SmartPhone®, RIM Blackberry®, Palm Garnett®, or similar device, for example. Client software 70 may include various communications functions to receive alerts, provide authentication, select/control video source 12, decode/decompress video frame packets, and display/render frames to provide streaming video to the user as illustrated and described in greater detail with reference to FIG. 6.

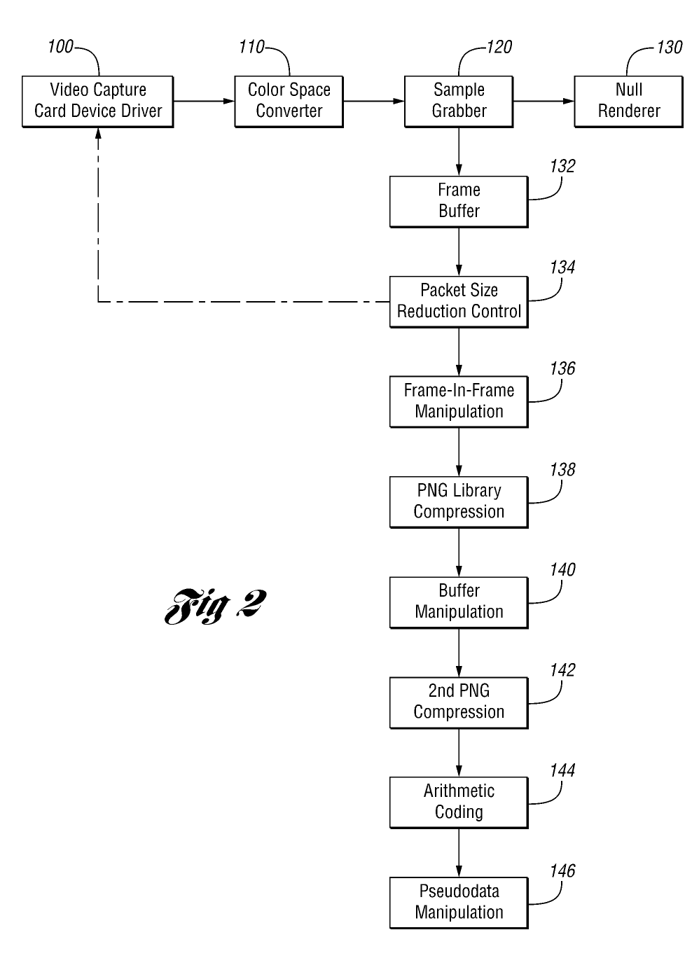

As generally illustrated in the representative security/surveillance embodiment of FIG. 1, a system or method for streaming video in near real-time having camera-to-user latencies as low as 6 seconds may receive an alert or trigger signal from alarm system 34 via an appropriate server interface as previously described. Server 32 sends a corresponding alert message, such as a text message, email, etc. to hand-held device 64. Hand-held device 64 transmits authentication information that may include an automatically transmitted device ID and user PIN or password to request streaming video from one or more cameras associated with the alert condition and directly or indirectly connected to server 32. To enhance security, server 32 transmits video from video source(s) 12 only in response to an authenticated request and streams the video directly from server 32 to hand-held communication device 64. Once an authenticated logical connection 72 is established, hand-held device 64 may be used to initiate/select a video stream from cameras 14, 16, 18, and/or 20. As described in greater detail with reference to FIGS. 2-6, server 32 cascades various technologies to capture, format, compress, and encode the video information to achieve an overall lightweight (low overhead) data packet for transmission while retaining image properties that keep the video stream recognizable. The process may be dynamically adjusted based on available network bandwidth and picture viewing requirements.

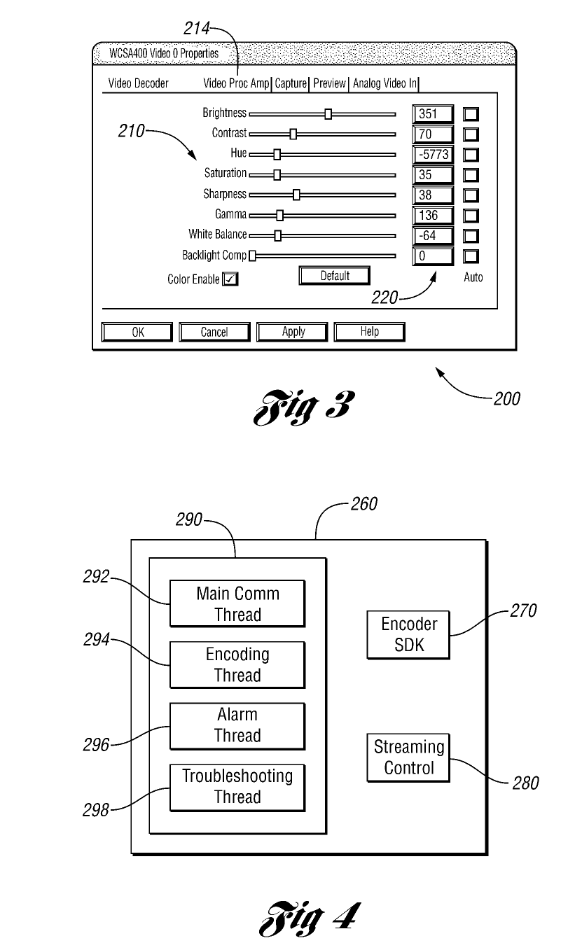

FIGS. 2 and 3 illustrate a representative embodiment of functions performed by server 32 (FIG. 1). FIG. 2 is a block diagram/flowchart illustrating operation of a system or method for packetizing video data for transmission over a low bit-rate channel or network, such as a cellular network, according to one embodiment of the present disclosure. The functions illustrated in FIG. 2 are implemented by software and/or hardware of server 32 (FIG. 1). A raw video signal in NTSC, PAL, or digital format is provided to a video capture card contained in a peripheral slot of server 32. An associated video capture card device driver 100 is a software component that sets/controls various parameters associated with the video capture card. The device driver software is generally specific to the manufacturer of the video capture card and usually supplied by the card manufacturer. For example, the Filter Graph Manager program (GraphEdit®) supplied by Microsoft corporation with the associated DirectX® Software Developer's Kit (SDK) presents the video capture card drivers as a capture device with various image properties 210 associated with the video processing amp 214 that can be manually adjusted using slider bars or attribute values 220 displayed by a graphical user interface 200. Image properties or attributes 210 available for manual or automatic control may vary based on the particular camera, video capture card, and version of device driver. For the representative embodiment illustrated, image properties that may be adjusted include brightness, contrast, hue, saturation, sharpness, gamma, white balance, and backlight compensation. As described in greater detail below, systems and methods according to the present disclosure interface directly with the device driver to automatically adjust at least one image property to reduce the data size of an associated captured video frame below a threshold so that subsequent processing provides a video data packet having a size suitable for transmission over a low bit-rate network as generally represented by block 134. The device driver may also be used to control or select the output format for the video provided by the capture card, which may depend on the format(s) provided by the connected camera(s). For example, the device driver may be used to select RGB output or YUYV output if both formats are made available by an attached camera.

Video data supplied by video capture card device driver 100 with selected property attribute values for one or more properties/attributes as represented by the GUI of FIG. 3 is passed to a color space converter 110 that transforms output from the camera to a first color palette for further processing. This reduces the packet size by quantizing color information using a palette having a smaller number of color values than the standard RGB bit values. In one embodiment, color space converter 110 transforms camera output to an eight-bit RGB color palette (RGB-8). Both the raw RGB values and the color palette are pushed to the next cascading stage as represented by sample grabber 120, which intercepts data that would normally be destined for display on a local monitor associated with server 32. Sample grabber 120 intercepts this data for further processing as generally represented by blocks 132 through 146. Null renderer 130 is provided to comply with DirectX® requirements for proper functioning of the filter graph in a representative embodiment, but otherwise plays no role in processing of the video stream.

Video data intercepted by sample grabber 120 is stored in a circular FIFO sample or frame buffer 132. Frame buffer 132 is a memory location that temporarily stores a prescribed number of frames or amount of video data with the oldest frame being discarded each time a new frame arrives in a first-in, first-out (FIFO) fashion. Multiple frames may be stored for processing in frame buffer 132 with the number of frames depending on the particular application and implementation. In one embodiment, frame buffer 132 holds only one frame for processing at a time.

The data size of the video frame currently selected for processing is examined by packet size reduction control 134, which automatically adjusts a selected image property or attribute to reduce the data size of the captured video frame, compares the resulting data size to a first threshold, and repeatedly adjusts one or more properties for each of the plurality of images in sequence until the resulting data size is below the corresponding threshold. The threshold may be dynamically modified based on currently available network bandwidth of the cellular network and/or any intermediate network or networks. Frames having a size that exceeds the associated threshold may be discarded. Packet size reduction control 134 continues iteratively examining frame data size and adjusting one or more image properties or attributes via video capture card device driver 100 to produce frames with a data size below the threshold. This process may take 30-50 frames to stabilize and is typically only required at the beginning of a video stream, or when the video content or available network bandwidth changes significantly. However, the process may be repeated as often as necessary to meet the required system parameters, such as image quality, network bandwidth, and corresponding video packet data size, for example.

An optional frame-in-frame manipulation may be performed as represented by block 136. For various compression strategies, higher compression efficiency may be obtained by processing a larger chunk of data. As such, a data reduction advantage may be obtained according to the present disclosure by combining multiple frames into a single composite frame having a larger size. In one embodiment, each captured video frame n has a vertical resolution of r pixels and a horizontal resolution of c pixels. The frame-in-frame manipulation 136 combines n² frames in an n-by-n array to form a single composite frame having a vertical resolution of nr and a horizontal resolution of nc. The composite frame is then processed as a single frame. For applications that do not include frame-in-frame manipulation 136, the captured frame of suitable data size is passed directly from block 134 to block 138.

Each frame is converted to a bitmapped image format using a lossless compression algorithm to generate a first compressed frame in a format native to the hand-held computing device 64 (FIG. 1) as represented by block 138. The present disclosure is independent of the particular algorithm and format utilized. However, the Portable Network Graphics or PNG format specifies a lossless compression algorithm and bitmapped image format for still images that is suitable for use in video streaming to a hand-held device as described herein. As such, in the representative embodiment illustrated in FIG. 2, block 138 converts the captured video frame data from RGB-8 to a first (eight-bit) PNG format (PNG-8) using a standard PNG library with the PNG-8 representation buffered in memory. This results in an average packet size reduction of about 67%.

Buffer manipulation as represented by block 140 may be used to remove at least one header or other overhead data block from the PNG data to further reduce the packet size. As used herein, a header specifies administrative or overhead information used in packetizing the data and may include data fields located anywhere in a formatted packet or file, such as at the beginning of the file, at the end of the file (sometimes called a footer or trailer), or in the middle of the packet/file. In general, a standard PNG file includes a PNG signature followed by a series of data chunks, some of which are designated critical chunks. In one embodiment, non-critical chunks are removed by buffer manipulation 140 including the “IHDR” chunk, the “IEND” chunk, and the PNG signature leaving only the “IDAT” chunk to further reduce packet size for subsequent processing and transmission over the low bit-rate network.

A second PNG compression is performed as represented by block 142. The second PNG compression uses a PNG library to compress/convert the frame data to a second PNG format. In one embodiment, block 142 converts the frame data from PNG-8 to PNG-4 or four-bit PNG representing 16 colors and providing another 33% reduction in packet size. The resulting frame data is again compressed using a second lossless compression algorithm as represented by block 144 to generate a compressed packet for transmission. In one embodiment, an arithmetic coding algorithm is applied. As known by those of ordinary skill in the art, arithmetic coding is a form of variable-length entropy encoding that converts a string into another representation that represents frequently used characters using fewer bits and infrequently used characters using more bits with the goal of using fewer bits in total. In contrast to other entropy encoding techniques that separate the input message into its component symbols and replace each symbol with a code word, arithmetic coding encodes the entire message into a single number between zero and one. In one embodiment, a varying code word or alphabet that changes dynamically from packet to packet is used with the alphabet represented by changes from a previous alphabet, which is only periodically transmitted (after some number of frames). When the new alphabet is transmitted, it is sent as the characters that have changed relative to the last transmitted alphabet, which significantly decreases the size and number of alphabet transmissions.

Pseudodata manipulation is then performed on the resulting compressed video frame as represented by block 146. Pseudo data manipulation is a frame replenishment strategy that takes advantage of the considerable similarity between successive frames. Portions of the image that do not change over two or more frames are not transmitted. At the display, these portions are reconstructed simply by repeating from the previous frame. The changing portions of the image that are sent are coded with varying resolution depending on subjective requirements for acceptable picture quality and the bandwidth available for transmission. For example, a first frame is sent in its entirety with the next three frames captured by the camera discarded. The first frame is then compared with the fifth frame to determine the differences or changes between these non-consecutive captured frames with only the differences or changes compressed, coded, and transmitted. On average, sending only the changes relative to a previous frame may result in a 50% reduction of transmitted data. At the hand-held receiving device, the first frame is used in combination with the changes to generate the complete fifth frame. A smoothing algorithm is then used to replenish or fill-in intervening frames. The combination of discarding frames and transmitting only the changed data allows creation of five frames from the equivalent of 1.5 frames of data to achieve an overall reduction of transmitted data of around 70% relative to transmitting five full frames of data.

Referring now to FIG. 4, a block diagram illustrating organization of software running on the server computer for video streaming according to various embodiments of the present disclosure is shown. The server software may be stored on a computer readable medium 260, such as a computer hard disk, for access by one or more processors during execution of the software. The main communication software 290 includes a main communication thread 292, an encoding thread 294, an alarm thread 296, and a troubleshooting thread 298. Software 290 operates as the communication server for the client software installed on mobile device 64 (FIG. 1), as well as the main integration software component on server 32 (FIG. 1). In this representative embodiment, the DirectX® subsystem contained within all versions of Windows® software is encapsulated by the encoder 270. This allows the streaming control software 280 to start and stop capture of video in addition to processing and compressing the captured video stream. As previously described, the video stream is captured and processed only in response to a request from an authenticated mobile device to improve security and to conserve processing resources.

Server software 290 includes several threads running concurrently as represented by blocks 292, 294, 296, and 298. Main communications thread 292 functions as the main entry point into the server system and processes all network-based communications, mainly from the client software 70 (FIG. 1). Main communications thread 292 is responsible for negotiating and establishing the logical connection or communication link 72 (FIG. 1). Encoding thread 294 is responsible for capturing and encoding a video steam as requested by the client software. Alarm thread 296 monitors any alarm interface to determine whether an alarm or trigger event has occurred as determined by a voltage change according to the alarm specifications. In one embodiment, alarm thread 296 checks the alarm interface at periodic intervals, such as every 30 seconds. Of course, the monitoring frequency may vary depending upon the particular triggering event being monitored and depending on the specific application and implementation. Troubleshooting thread 298 monitors the state of the current logical connection 72 (FIG. 1). If a breach in the current logical connection is detected by troubleshooting thread 298, the entire session is dumped or discarded to release the server resources for further use. As previously described, the encoder SDK 270 wraps or encapsulates the DirectX® subsystem and allows an application to capture and process video. Streaming control 280 is the streaming server portion that allows multiple clients to connect to various available video streams after authentication.

In operation, and with reference to FIGS. 1 and 4, server software 290 remains idle waiting for a client connection request from client software 70 installed on a hand-held mobile device 64, while alarm thread 296 monitors alarm/trigger signals of alarm system 34 provided by a data acquisition system or ADC card installed in server 32. If the alarm voltage exceeds a specified value (depending upon the particular system being used), this will trigger alarm thread 296 to send a message (text/SMS or email, for example) to the mobile device to alert the end user of the trigger event. The message may be composed by server 32 and relayed to an email server through an ISP, directly to the end user via SMS/text messaging to the cellular telephone number, or via a third-party monitoring service, for example.

The client software 70 on mobile hand-held computing device 64 may be used to request a corresponding video stream in response to an alert message, or simply upon initiation by the user without requiring an alert or alarm trigger. When a communication request is generated by client software 70 on hand-held mobile device 64 is received by server 32, communication thread 292 completes TCP/IP negotiation and requests authentication of hand-held device 64, which may include automatic transmission of a mobile device ID, such as a serial number, or other code that may be embedded within the hardware and/or software on the mobile device. A password or PIN entered by the user may also be required to enhance security and prevent unauthorized users from accessing streaming video if the hand-held device is lost or stolen. Once the authentication is successfully completed, a capture and encoding session is initiated by encoding thread 294 and encoder SDK 270. Streaming control 280 then manages delivery of the packetized video data to the appropriate mobile device 64, while troubleshooting thread 298 continues to monitor the session status. If the streaming session is interrupted, troubleshooting thread 298 ends the session on server 32 to release server resources for future use. Once an authenticated communication link has been established, mobile device 64 may be used to view and/or control appropriately equipped cameras 14, 16, 18, or 20 and/or initiate video streaming sessions from other cameras without additional authentication. Alternatively, an authenticated session may time out after a period of inactivity and/or a predetermined time period such that re-authentication is required to enhance system security.

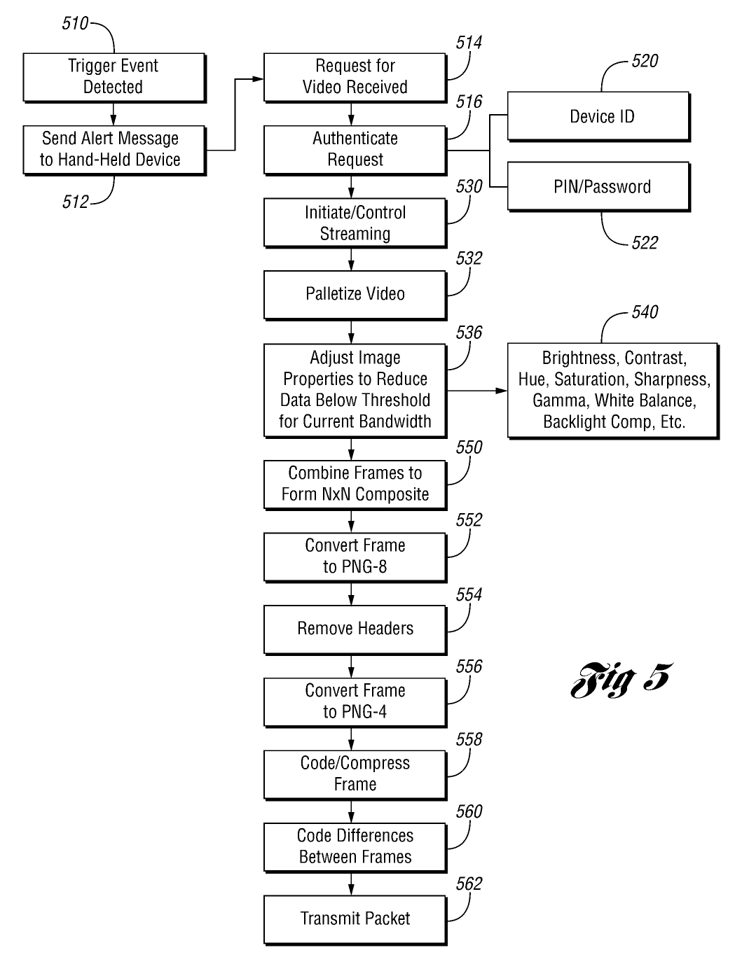

FIG. 5 provides an alternative representation of the operation of a system or method for streaming video performed by a server computer using data reduction, coding, and compression strategies according to various embodiments of the present disclosure. Block 510 represents detecting a trigger event or alert associated with at least one video source or camera and, in response, sending a message to at least one user of a hand-held device based on the alert to request streaming video associated with the at least one camera be transmitted to the hand-held device as represented by block 512. Those of ordinary skill in the art will recognize that the functions and/or components associated with implementation of blocks 510 and 512 are optional. When provided, these features alert the user of the trigger event by sending a message, such as a text/SMS message to the hand-held device to elicit a user request for viewing associated streaming video.

Block 514 represents receiving a request for streaming video form a hand-held computing device. The request may be in response to an alert message provided by block 512, or user-initiated without regard to any alert. The system and method include determining that the hand-held device is authorized to receive requested streaming video by initiating an authentication request as represented by block 516. Determining that the device is authorized may include determining an embedded device identification (ID) code as represented by block 520 and/or processing a username/password entered by a user as represented by block 522. An embedded device ID may be stored in hardware and/or software on the device and may be automatically transmitted with messages sent by the device, such as a device serial number, for example. The device ID may also include information relative to the client software version, operating system, device type, etc. In one embodiment, the device ID may include a cellular telephone identification code.

Once the hand-held device is authenticated, the initiation/control of a video streaming session is started as represented by block 530. The initiation/control may include a video source selection corresponding to one of a plurality of available cameras as specified by a configuration file stored on the mobile device. The video data may be palletized as represented by block 532 by transforming output form an associated video source, such as a camera, to a first color palette. In one embodiment, camera output is transformed to an RGB-8 color palette. The system and method continue by adjusting one or more of a plurality of image properties until a captured video frame data size is below a corresponding threshold. The threshold may be dynamically modified based on currently available network bandwidth or based on the average content of a particular video source, for example. Image properties or attributes may be adjusted by controlling a device driver associated with the video source and/or the video capture card installed in the server computer. Image properties may include at least two properties selected from brightness, contrast, hue, saturation, sharpness, gamma, white balance, and backlight compensation as represented generally by block 540. Although these attribute or property names/labels are generally standardized, the names/labels may vary and different attributes may be available depending upon the particular video capture card manufacturer, camera manufacturer, device driver supplier, etc.

Those of ordinary skill in the art will appreciate that the process represented by block 536 is an iterative process that may require on the order of 30-40 frames to stabilize depending on the particular frame content and initial values. In general, once established, attribute values will remain within a small range dependent upon the average image content and camera settings. The process may be repeated as necessary to adjust to available network bandwidth. In one embodiment, block 536 adjusts a selected image property to reduce the data size of the captured video frame, compares the resulting size to a threshold, and repeatedly adjusts the selected attribute and/or additional selected attributes while comparing each resulting frame to the threshold. The process is then repeated by further adjusting the first selected image property or attribute until the frame data size is below the threshold. Various constraints may be placed on the process for individual attributes so that the quality of the resulting streaming video remains acceptable to the user to view on the hand-held device.

Block 550 of FIG. 5 represents an optional process for enhancing the compression ratio of the resulting video data packets by combining multiple image frames to form a single composite frame. In general, the process combines n² frames in an n by n array, i.e. n frames across and n frames down and treats the resulting array as a single frame for further processing. As such, if each frame has a vertical resolution of r pixels and a horizontal resolution of c pixels, the resulting combined frame would have a vertical resolution of nr and a horizontal resolution of nc. The frame data passes to block 552, which includes converting the captured video frame data to a first bitmapped image format using a lossless compression algorithm to generate a first compressed frame. The bitmapped image format may be a format native to the hand-held device. In the representative embodiment illustrated, the frame data is converted to eight-bit PNG format (PNG-8) using the lossless compression algorithm specified by the PNG format. Most formats include various field identifiers, header/trailer information, etc. provided to enhance compatibility among various systems that may be removed for interim processing to further reduce the packet data size as represented by block 554. For example, the PNG format includes a file signature followed by a series of chunks with block 554 removing the file signature, the IHDR chunk, and the IEND chunk to further reduce the packet size. The resulting frame data is then converted to a second bitmapped image format using a lossless compression algorithm, such as PNG-4 in the illustrated embodiment. The compressed frame is then coded and further compressed using an arithmetic coding strategy as represented by block 558.

Additional data reduction may be accomplished by the optional processing represented by block 560 where selected frames are discarded and the remaining frames are processed to determine differences between the frames with only the difference being coded as previously described in detail. The resulting data packet is then transmitted by the streaming server to the cellular provider over the internet for wireless transmission to the hand-held mobile computing device.

Referring now to FIG. 6, a block diagram illustrating operation of a system or method for displaying video streamed over a wireless network on a hand-held computing device according to one embodiment of the present invention is shown. The various functions illustrated generally represent the process implemented by client software 70 to generate a stream of image frames on a display 66 of hand-held device 64 using received video packets. When the client application is launched, the end user may select a particular location and a particular video source for viewing as part of the video stream request as represented by blocks 600 and 606. Authentication information, such as a device ID and/or PIN/password may also be supplied to the server to establish an authenticated session as represented by blocks 604 and 606, respectively. Once authenticated, the client application will begin to receive frame data packets for the selected video source as represented by block 602, and may spawn another process to begin rendering image frames decoded by blocks 604-612 on the display device as represented by block 614.

The optional process represented by blocks 604 and 606 recreates frames that were discarded to reduce the data packet size prior to transmission by the server by decoding the packet information to generate differences relative to a base or reference image frame. The resulting image frame and the reference image frame are supplied to a smoothing or frame replenishing process as represented by block 606 to fill in intervening frames. The frames are then decompressed or decoded as represented by block 608. The optional process represented by block 610 is employed to decompose or separate individual frames if the corresponding frame-in-frame compositing process was used by the server. The resulting data packet is properly formatted for the desired image format as represented by block 612. For example, in the representative embodiment illustrated, the PNG file signature, IHDR chunk and IDAT chunk are added to properly format the file for rendering of the image as represented by block 614. The process is repeated for subsequent image frames to generate a video stream based on sequential rendering of bitmapped images.

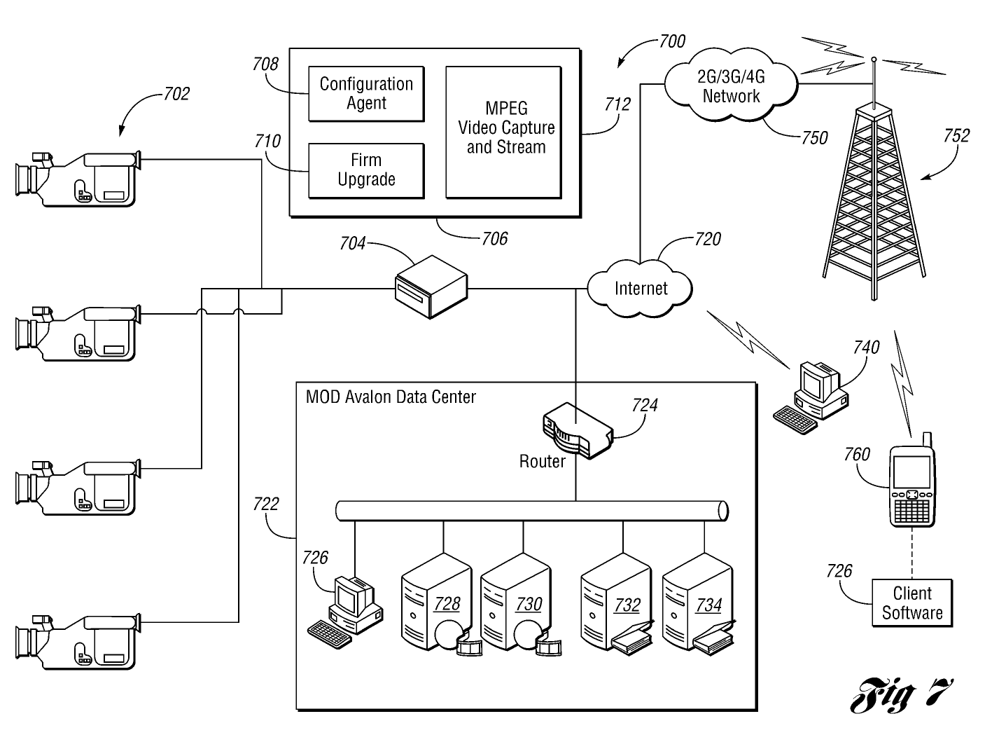

FIG. 7 is a block diagram illustrating a representative system architecture for a video distribution and management system according to various embodiments of the present disclosure. System 700 may be used for managing distribution of streaming video from a video server over a limited bandwidth channel, such as a cellular network, to a handheld device. The representative embodiment illustrated in FIG. 7 is similar to the embodiment illustrated in FIG. 1 unless otherwise described. System 700 includes at least one camera 702 in communication with a video server 704. Video server 704 includes hardware and associated software as generally represented by 706. Representative software modules or functions may include a configuration agent 708, a firmware upgrade agent 710, and a video capture, encoding, and streaming module 712, for example. Various other functions may be provided depending on the particular application and implementation. Representative functions are described in greater detail herein. Video server 704 may include various commercially available components with customized software and/or firmware to capture video from at least one camera 702 in communication with video server 704 in response to a request from a handheld device, such as mobile device 760. Video server 704 compresses and encodes the video captured from at least one camera 702 for subsequent broadcast or communication to mobile device 760 over one or more networks, which may include the Internet 720 and/or a wireless cellular network generally represented by 750 and cellular antenna/tower 752. Video server 704 may include one or more persistent or non-volatile storage devices, such as a hard disk, flash drive, solid-state drive (SSD) or the like to store various software and recorded video. In one embodiment, video server 704 includes an internal hard disk having about 320 GB storage capacity, which is sufficient to store 70 days of video for 4 cameras 702 at 7 frames/second. Of course, the size and type of persistent storage may vary by application and implementation. Video server 704 may also communicate with one or more external storage devices to provide long-term or back-up storage functions.

In one embodiment, video server 704 includes firmware and/or software that performs or may be used to perform various administrative and operator functions. When video server 704 is powered up and connected to a network, such as the Internet 720, server 704 will periodically, or in response to a polling or similar request, report its status and various network information to one or more remotely located system computers as generally represented at 722. Network information may include available network bandwidth/traffic, transit/latency times, dropped packets, etc.

System computers 722 are connected via one or more routers 724 to a local and/or wide area network such as the Internet 720. In one embodiment, system computers include an administrator station, console, or computer 726, one or more cluster stream media servers 728, 730, a business/management server 732, and an authorization and configuration server 734. Those of ordinary skill in the art will recognize that various functions illustrated as being performed by different computers or servers may be combined or integrated into a single server depending on the particular application and implementation.

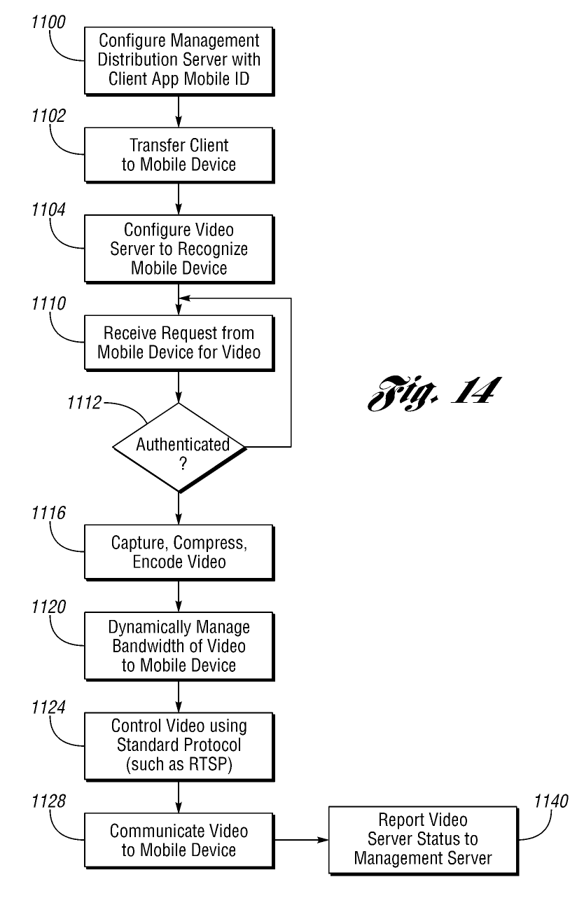

Video server 704 may include a web interface to connect with a remote computer or computing device using a web browser or similar user interface. The web interface of video server 704 may be used to perform various administrative, configuration, and user/operator control functions via configuration agent 708 and related software as generally illustrated and described with reference to FIG. 13. For example, a web interface running on video server 704 may be used to display and connect to available video from one or more connected cameras 702. In one embodiment, an Active X control or similar software application or control running on video server 704 facilitates display and control of available video and/or audio associated with one or more cameras 702 in communication with video server 704. For example, available video may be displayed on a video server 704 home page accessed by authorized/authenticated users after entering a user login and password or communicating authentication information, such as a mobile device identification, serial number, SIM card ID, etc. After login by a user, a home page is displayed using the web interface on video server 704 and may include various user controls and/or administrative functions, such as selecting audio/video, controlling a camera, changing user login/password information, changing video server settings and the like. Various controls/functions may only be available to selected users, such as administrators, based on the user login/password. In one embodiment, double clicking on one of the available video images displayed on a web page of video server 704, or a similar user request for viewing, results in a full screen image display. Similarly, subsequent double clicking returns to the selection screen/page. The web interface may also include camera controls, such as pan, tilt, and zoom, for example, to allow a remote user to control a selected camera 702 having associated control capabilities, which may vary depending on the particular type of camera.

FIG. 13 illustrates a representative web user interface for video server 704 to facilitate remote configuration and control of video server 704 according to various embodiments of the present disclosure. User interface 1200 may include one or more top-level menus or functions, which may each have one or more sub-menus/functions. For example, in the representative embodiment illustrated, web interface 1200 includes top-level menus/functions associated with basic configuration 1210, advanced configuration 1220, storage record 1222, and recording 1224. Basic configuration 1210 includes sub-functions/settings for device status 1212, video 1214, networking 1216, and date 1218, with the video tab 1214 selected and corresponding video settings 1230 displayed and described below. Device status settings may include settings to identify a management server, reporting frequency, and various device statistics. Networking configuration/settings 1216 may include various networking options and parameters, such as an internal (private) and/or external (public) IP address, DNS settings, port number specifications, DHCP or static addresses, and the like. Date configuration/settings 1218 may be used to set options relative to the current date/time, time zone, automatic daylight savings time adjustment, etc. Advanced configuration 1220 may include various maintenance, administrator, and alarm/trigger event settings. Storage record functions 1222 may include various settings related to options for storing video, such as how long to keep video, whether to transfer to a back-up device, maximum storage space for a particular channel, etc. Recording view 1224 may include options/settings for playback and associated controls.

In the representative embodiment illustrated, video settings 1230 include various drop-down lists and parameter entry boxes to control/select associated video settings. For example, a video channel may be selected using an associated drop-down list 1232. Similar controls may be provided for selecting CIF, QCIF, or other resolution 1234, variable or constant bit rate (CBR) of the live video streaming and recording 1236, and compression level 1238. Parameter entry boxes or fields may be provided rather than a drop-down list with associated valid parameter values displayed adjacent to the entry boxes. In the representative embodiment illustrated, video settings for brightness 1240, contrast 1242, saturation 1244, and hue 1246 may be provided. Similar menus, drop-down lists, buttons, parameter entry boxes, etc. may be provided for one or more of the sub-menus or functions previously described.

As also illustrated in FIG. 13, web interface 1200 may include video settings related to the video stream 1250, such as a frame rate limit of between 5-15 frames/second 1252, a P/I ratio 1254, and a camera type or format 1256. P/I ratio is used to select the ratio between the P frames and I frames used in various encoding strategies as previously described. Web interface 1200 may also include buttons or controls 1260 to save, reset, or load previously saved values/settings, for example.

Referring again to FIG. 7, system 700 may use one or more networks such as the Internet 720 and cellular network 752 provide streaming video from one or more cameras 702 to one or more remote devices such as mobile device 760 and computer 740. Computer 740 may communicate with Internet 720 using a wired or wireless network connection. Computer 740 may also communicate with video server 704 and one or more management computers 722 using a cellular network 750 pending upon the particular application and implementation. Computer 740 may request streaming video from one or more cameras 702 using a web interface posted by video server 704. Alternatively, or in combination, computer 740 may include a custom software application that provides various configuration and operation functions.

In one embodiment, mobile device 760 includes client software 726 that may be used to communicate with video server 704 and/or one or more management computers 722. Alternatively, mobile device 760 may use an Internet browser to access corresponding web interfaces of video server 704 and computers 722. As described in greater detail herein, mobile device 760 may establish a secure communication channel/session with video server 704 to receive streaming video from one or more cameras 702 using client software 726. In one embodiment, client software 726 may be distributed from a management server, such as authorization and configuration server 734 in response to a corresponding request from mobile device 760. Client software 726 may be customized for operation on various types of mobile devices 760. Functionality may vary depending upon the particular type and capabilities of mobile device 760 and/or client software 726.

Representative functions performed or facilitated by client software 726 may include automatically downloading a new version of the software from authorization and configuration server 734 when available. In addition, an initial setup/configuration may be performed when mobile device 760 and client software 726 are activated for the first time. Initial setup functions may include entering a username, password, and phone number, for example. Additional identification information may be entered by a user and/or automatically obtained from mobile device 760. Additional identification and/or authentication information may include a serial number, SIM card ID, phone number obtained through caller ID or similar service, etc. Automatically obtained identification information improves security by requiring the user to access video server 704 and or management computer 722 using a previously authorized device in the physical possession of the user. Automatically obtained identification information may be used in combination with authorization information entered by user, such as a username and password, so that mere possession of an authorized mobile device 760 is not sufficient to gain access to video server 704. After initial activation, mobile device 760 may download and access file from video server 704 for subsequent access to video from one or more cameras 702.

Client software 726 may also display various parameters associated with video server 704 and/or cameras 702 depending on the particular access privileges or rights associated with a particular user. Available information may include a company, location, video server identification, camera selection, and the like, for example. As described in greater detail below, after establishing communication with a video server 704, client software 726 may also display a still frame or preview of a video image captured by one or more cameras 702. In one embodiment, the preview is displayed using a browsing protocol such as HTTP while the regular view of a selected camera is displayed using a streaming protocol, such as RTSP. Client software 726 may allow viewing of live video or recorded video stored by video server 704. For historical or recorded video, client software 726 may be used to select a date and/or time for viewing video. In addition, video controls may be provided to move forward/backward within a particular video stream to skip designated time increments. For example, in one embodiment forward and reverse controls may be used to skip sections of a previously recorded video stream in one minute or one hour increments. Of course, other encodings may be provided depending upon the particular application and implementation. Likewise, additional controls, such as pause, slow motion, beginning of stream, and a stream, and the like may be provided. In one embodiment, streaming video provided by video server 704 is controlled by a remote device such as computer 744 mobile device 760 by communicating a real-time streaming protocol RTSP request from the remote device to video server 704 over one or more networks, such as Internet 720. In various embodiments, client software 726 may optionally be used to communicate a request associated with a change in required bandwidth from the remote device 740, 760 to video server 704. For example, a request the change in frame rate, or image resolution may result in a request for a change in required bandwidth. Alternatively, video server 704 may dynamically adjust various parameters associated with streaming video to meet bandwidth availability limitations of one or more networks 720, 750 as described in greater detail herein.

FIG. 8 is a block diagram illustrating operation of a system or method for video distribution and management according to various embodiments of the present disclosure. As described above with respect to FIG. 7, video server 704 may include various modules, components, and/or software 706 to perform or facilitate functions associated with distribution and management of video streams captured from one or more cameras 702. In the representative embodiment illustrated in FIG. 8, a configuration agent service 708 may be provided to settings/options of video server 704, such as those described above with respect to FIG. 13, for example. Configuration agent service 708 may communicate with a remote configuration application 780 using a network address/port represented by TCP socket 784, for example. Of course, various other networking or communication protocols may be used depending on the particular application. TCP socket 786 may be used to communicate between the remote configuration application 780 and an authentication and configuration server 734. Server 734 may include a configuration service for the video server as represented by block 770. In addition, server 734 may include an authorization and configuration service for one or more mobile clients 772. Similarly, a Web server interface 774 may be provided for initial setup functions. Server 734 may communicate with mobile clients 726 using an associated TCP socket 778 for authorization and configuration functions and/or a browsing protocol, such as HTTP 776, four associated web interface functions. For example, mobile five 726 may download client software for accessing video server 704 using HTTP service 774. Mobile clients 726 may subsequently establish communication using TCP socket 738 with the compression and encoding server software 712 of video server 704. Video server 704 may also include a firmware upgrade service 710 that communicates via a browsing protocol, such as a HTTP 788 over one or more local and wide area networks with a browser 782 running on a remote computer, such as computer 740 or administrator computer 726, for example.

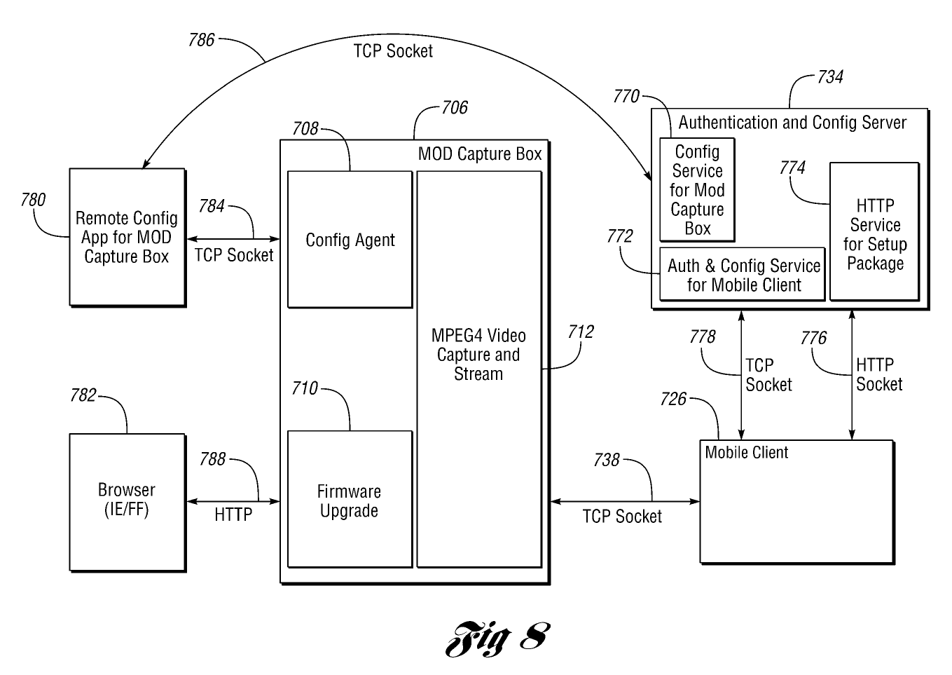

FIG. 9 is a block diagram illustrating representative data flow of a system or method for video distribution and management after establishing an authenticated connection according to various embodiments of the present disclosure. As illustrated in FIG. 9, a video camera 702 communicates video data via a wired or wireless connection to video server 704. Video camera 702 may communicate video information in an analog or digital format depending upon the particular application and implementation. For video cameras 702 having a native analog format, analog to digital conversion may be provided by an associated video capture card within video server 704. Various cameras 702 may have the ability to transmit video information directly in a digital format to video server 704. In response to a request received from a mobile device, video server 704 begins processing raw video data 800 and which is encoded using any of a number of strategies well known to those of ordinary skill in the art. In one embodiment, video information is encoded using the M-PEG4 (MP4) standard with the raw MP4 data pushed to an MP4 data pool as represented by block 804. IOCP service 810 pulls or pops the encoded video data in response to a request received from TCP/IP network 720. As such, video data is not broadcast over TCP/IP network 720 until a valid request for video is received from an authorized remote device, such as mobile device 760. In contrast to various prior art strategies, the “on demand” feature according to the present disclosure improves security and/or privacy of the video stream because the video stream is available outside of video server 704 only when requested by an authorized remote device. The video stream is sent directly to mobile device 760 and may be communicated using any of a number of secure protocols to transmit the video data stream if desired. This on-demand feature also has the associated benefit of limiting the bandwidth and usage of carrier networks and reduces the probability of streaming video being intercepted by unauthorized users.

As also illustrated in FIG. 9, mobile device 760 may include client application software generally represented by 726. Client software 726 is used to establish a connection between video player 830 and video server 704 as previously described. After receiving a valid request from an authorized mobile device 760, video server 704 communicates video stream data over TCP/IP network 722 mobile device 760. The video stream is received in a rendering data queue 820. The rendering data queue at file header information and contain information to create a valid MP4 encapsulated data stream within data queue 822. Depending upon the particular application and implementation, video player 830 may include various controls to control the playback of the video stream. Mobile device 760 may include sufficient onboard storage to archive video stream data for delayed viewing. The compression and encoding strategies described herein facilitate storage of a significant quantity of video information on the relatively limited resources available to a mobile device. In particular, use of a mobile design rather than a typical desk top computer design provides better compression ratios resulting in a significantly longer storage time, which may be an order of magnitude longer, with archive video available on the mobile device. The use of variable compression algorithms facilitates dynamic throttling of the required bandwidth by dynamically changing the compression strategy and/or algorithm in response to network conditions and/or a user request. This allows better management of video streaming and facilitates adaptation to changing network conditions.

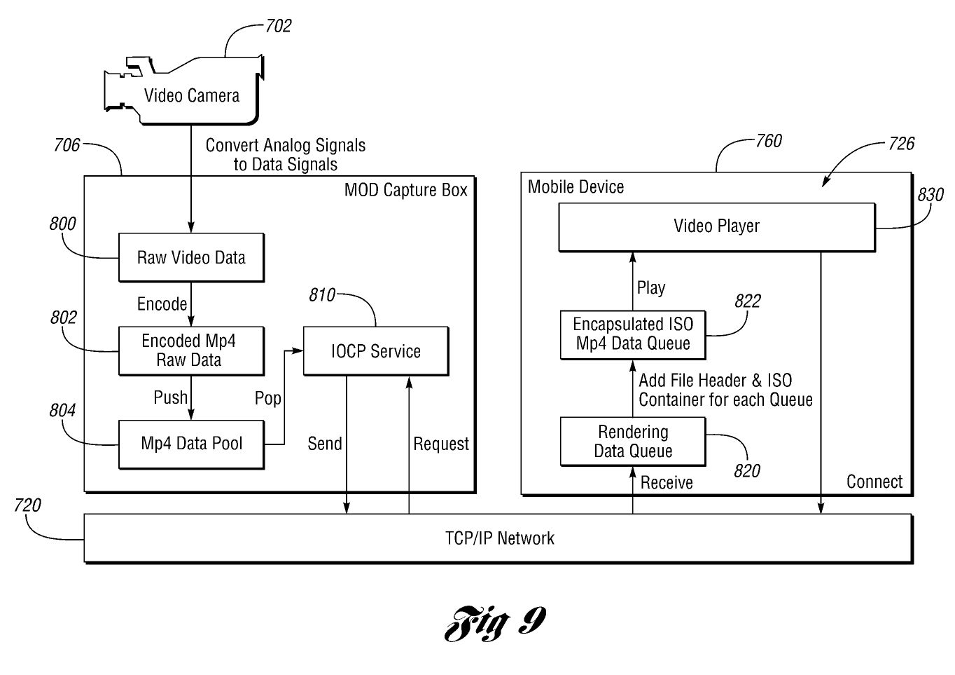

FIG. 10 is a state machine diagram illustrating operation of a representative video streaming control in a system or method for video distribution and management according to various embodiments of the present disclosure. The state machine 810 illustrated in FIG. 10 may be implemented as a customized TCP socket protocol similar to the real-time streaming protocol (RTSP). The representative state diagram illustrated provides states for initialization 840, ready 850, playing 860, and pause 870. Of course, various other states may be provided to pending upon the particular application and implementation. Starting from the initialization state 840, an authorization method communicates authentication information to the video server and receives a corresponding reply or authorization state. Information returned by the server in response to a request from the client may include various status codes. For example, a success code may be provided indicating that a request has been successfully received, understood, and accepted. Various error codes may be provided to indicate an unauthorized request, such as when authentication is possible but has failed, or has not yet been completed. Various client error codes may be provided that include an explanation of the error situation and whether it is a temporary or permanent condition. Client error codes may apply to any request method and are typically the most common codes encountered. Server error codes may also be returned when the server fails to fulfill an otherwise valid request. Server error codes may include an indication that the server is aware that it has encountered an error or is otherwise incapable of performing a request. Server error codes may also include an explanation of the error situation and indicate whether it is a temporary or permanent condition. Of course, various other codes may be provided to facilitate analysis of client/server communications depending upon the particular application and implementation.

Returning now to FIG. 10, if the authorization state is invalid, the authorization results in failure as represented by 842 and the state machine remains in the initialization state. Upon authenticating a communication session, the state changes from initialization 840 to the ready state 850 as represented at 846. Ready state 850 may return to the initialization state 840 upon receiving a tear down request 848 representing a disconnection or termination of the communication session.

Upon receiving a request to play video data as represented at 852, the state transitions from the ready state 850 to the playing state 860. A corresponding play method is executed to get available video data from the video server as previously described. The video stream continues to play as represented at 862 until receiving a tear down request 864, which results in a return to initialization state 840, or a pause request 866, which results in transitioning to pause state 870. Pause state 870 continues until receiving a subsequent play request 868, which results in returning to playing state 860, or a tear down request 872, which results in returning to initialization state 840. Various other methods may be provided within the TCP socket protocol. For example, methods may be provided to change a selected configuration parameter and to retrieve a current value for a selected configuration parameter, for example.

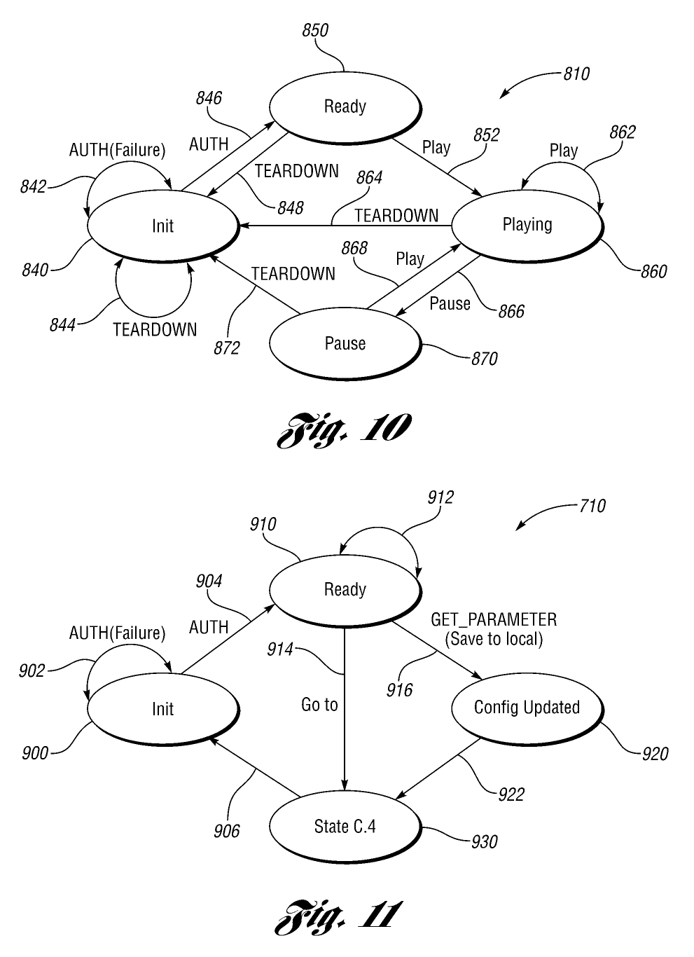

FIG. 11 is a state machine diagram illustrating operation of a representative configuration update function in a system or method for video distribution and management according to various embodiments of the present disclosure. State diagram 770 includes an initialization state 900, a ready state 912, a configuration updated state 920, and an idle state 930. Initialization state 900 is the default operating state entered upon power up. Attempted authorization or authentication requests which are invalid result in staying in the initialization state as generally represented by 902. Upon receipt of a authenticated or authorized request as represented by 904, the state transitions to ready state 910. Ready state 910 is maintained while receiving configuration updates as represented by 912. When the update is completed, a corresponding parameter or flag is set as represented at 916 and the current state transitions to state 920. After the configuration state has been updated, the current state transitions to idle state 930 as generally represented by 922. Idle state 930 indicates that a valid local configuration exist on the remote/mobile device. As also illustrated, ready state 910 may also transition to idle state 930 as generally represented at 914. Similarly, initialization state 900 may transition to idle state 930 if a valid local configuration is detected upon power up or initialization of the client software.

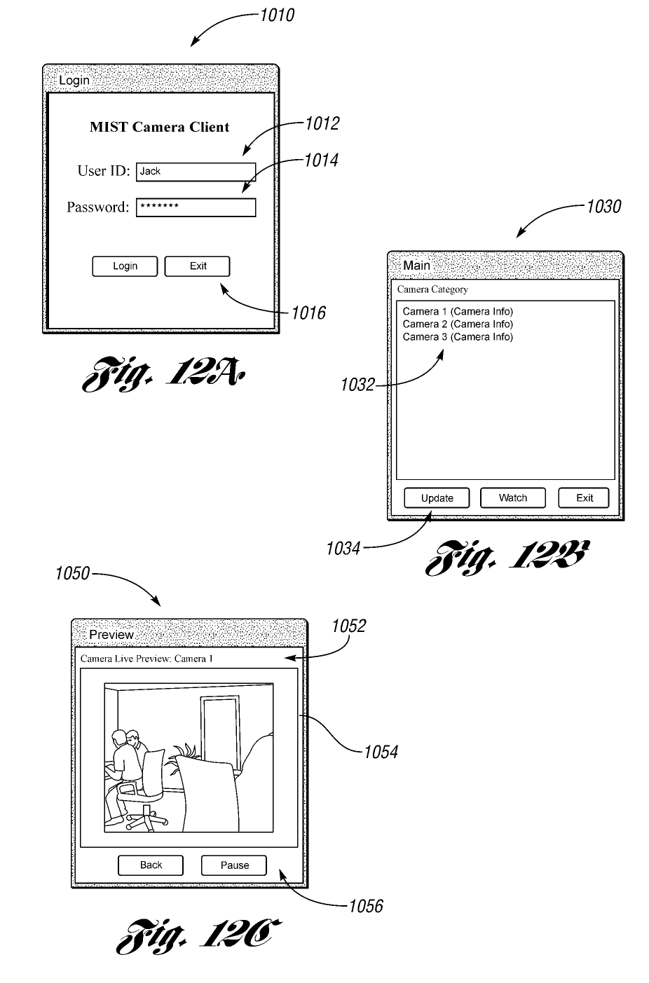

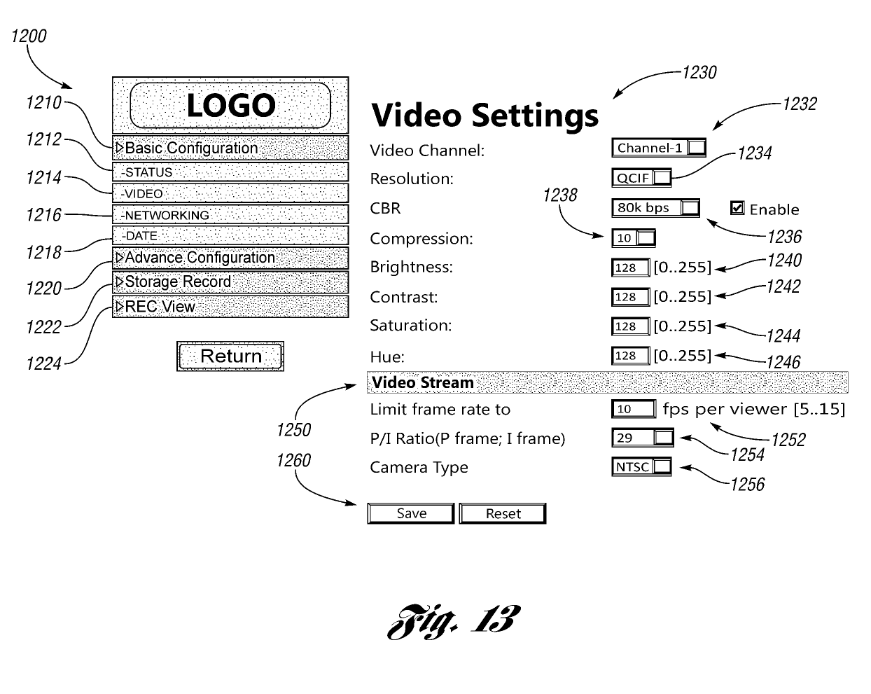

FIGS. 12A-12C illustrate representative user interfaces for a system or method for video distribution and management according to various embodiments of the present disclosure. User interface 1010 is representative of a login or authentication interface provided using standard web interface tools by video server 704 to a remote computer 740 or mobile device 760. User interface 1010 includes a first data entry box 1012 and associated descriptive text for entry of a user ID and a second data entry box 1014 and associated descriptive text for entry of a corresponding password. Interface 1010 may also include one or more buttons 1016, menus, lists, and the like to facilitate the login and authentication process. User interface 1030 or a similar interface may be used to select one of a plurality of cameras as generally indicated at 1032 for configuration or viewing using associated buttons 1034. User interface 1050 illustrates a representative preview image displayed after selection of a camera from the user interface 1030. Interface 1050 includes a title bar 1052 that may include descriptive information relative to the selected preview. An image display area 1054 may be used to display a captured frame from the requested video stream to provide a preview for the selected camera. Various buttons 1056 may be used to facilitate user navigation and operation of the video server and associated video streaming software.

FIG. 14 is a flowchart or block diagram illustrating operation of a system or method for video distribution and management according to various embodiments of the present disclosure. Similar to the block diagrams of FIGS. 5 and 6, the diagram of FIG. 14 is a simplified flowchart illustrating representative strategies for operation of a video distribution and management system or method. The control strategies and/or logic illustrated is generally stored as code implemented by software and/or hardware associated with a microprocessor based computer and/or mobile device. Code may be processed using any of a number of known strategies such as event-driven, interrupt-driven, multi-tasking, multi-threading, and the like. As such, various blocks or functions illustrated may be performed in the sequence illustrated, in parallel, or in some cases omitted. Although not explicitly illustrated, one of ordinary skill in the art will recognize that one or more of the illustrated functions may be repeatedly performed depending upon the particular processing strategy being used. Similarly, the order of processing is not necessarily required to achieve the features and advantages described herein, but is provided for ease of illustration and description. Of course, the control logic may be implemented in software, hardware, or a combination of software and hardware in one or more dedicated computers/mobile devices and/or general purpose devices executing the code to implement the illustrated functions depending on the particular application and implementation. When implemented in software, the control logic may be provided in one or more computer-readable storage media having stored data representing code or instructions executed by a computer. The computer-readable storage media may include one or more of a number of known physical devices which utilize electric, magnetic, optical, and/or hybrid storage to keep executable instructions and associated calibration information, operating variables, and the like.

Block 1100 of FIG. 14 represents configuring a distribution server with a handheld client application and identification information for a selected handheld device. The client application is transferred to a remote computer and/or mobile device as generally represented by block 1102. In one embodiment, a client application is transferred from a management or distribution server to a mobile device using a web interface over the Internet and an associated cellular network. Of course, various other distribution channels may be employed to deliver an appropriate client application to a remote computer or mobile device for subsequent use in viewing a video stream. As also illustrated in FIG. 14, the system and method may include configuring a video server in communication with at least one camera and in selective communication with the distribution server to recognize the handheld device as represented by block 1104. For example, the video server may be accessed locally or remotely by an authorized user to enter mobile device identification information, user IDs, and/or passwords for subsequent authentication and access to available video.

Block 1110 represents receiving a request from a mobile device to access the video server. The video server determines whether the mobile device is authorized to receive a requested video stream as represented by block 1112. If authentication fails, the process continues to wait for an authorized request for video. If the remote device has been authenticated and inappropriate requests for video has been received, the system or method capture, compress, and encode video from the at least one camera in communication with the video server as represented by block 1116. Various encoding and compression strategies and/or algorithms may be adjusted to dynamically manage the required bandwidth of the video stream beam prepared for communication to a remote device as represented by block 1120. As those of ordinary skill in the art will recognize, bandwidth requirements may be managed based on the currently available bandwidth of one or more of the networks used to communicate the video stream, such as the Internet and/or a cellular network. The captured video stream may be controlled as generally represented by block 1124 using a customized or standard protocol such as RTSP, for example. In response to an associated request, such as play, the video stream is communicated to the remote/mobile device as represented by block 1128. The system and method may periodically communicate video server status information to a management and/or distribution server in communication with the video server via the Internet as generally represented by block 1140. Status information may include various statistical information associated with available network bandwidth, errors, and the like.

As such, various embodiments according to the present disclosure provide a web portal for centralized management and distribution of streaming video to various display devices including mobile devices. Internet access to a video distribution and management server facilitates registration, downloading, installation, and set-up of client application software in addition to associated server side configuration. Centralized management and distribution may also provide more convenient business management and facilitates implementations that support the Software as a Service (SAAS) business model. Various embodiments according to the present disclosure facilitate integration of commercially available components to provide video capture and compression with customized embedded streaming controls based on standard video streaming protocols to provide a cost effective wireless video surveillance system allowing users to view live streaming video on a handheld device.

Embodiments according to the present disclosure may combine or cascade various compression, encoding/decoding, and data reduction strategies to generate a lightweight or lower bandwidth stream of data packets representing video information for transmission to a portable hand-held device over a relatively low bandwidth/bit-rate, and generally unreliable network, such as a cellular network, for example. The data packets received by the mobile device are manipulated in near real-time to produce a recognizable video stream on the mobile device with camera to user latency times on the order of just seconds. Security features allow only authorized users to initiate, control, and view a selected video stream. The client/server architecture employs a hardened server with a minimal operating system to facilitate installation of the server on the public side of a network firewall, or in a firewall demilitarized zone, if desired. Additional security features include capturing and processing video data for transmission only after an authenticated hand-held device requests streaming video with authentication provided by a security code or number embedded in the device hardware or software in addition to entry of a user PIN or password. A mobile user can select from available video streams and may have the ability to remotely control one or more appropriately equipped video sources once the hand-held device is authenticated. The scalable design illustrated by representative embodiments of the present disclosure allows a single server implementation to process data from multiple cameras providing near real-time video streaming to multiple users substantially simultaneously.

In addition, the video streaming systems and methods of the present disclosure have the ability to transmit packetized video data using streaming technology native to the mobile devices for display of still images, i.e. developed specifically for mobile devices to facilitate viewing of full motion video over a low bit-rate network, i.e. at less than modem speeds using a client application based on video player technology rather than web page still image display technology to reduce transmission bandwidth and processing requirements of the mobile device.

Embodiments of the present disclosure may be easily integrated into existing video surveillance or security applications interfacing with access control, intrusion detection, security, and automation systems, for example. Alerts, such as text messages, emails, or other information may be transmitted to mobile users in response to a security trigger being activated at a monitored site.

While one or more embodiments have been illustrated and described, these embodiments are not intended to illustrate and describe all possible embodiments within the scope of the claims. Rather, the words used in the specification are words of description rather than limitation, and various changes may be made without departing from the spirit and scope of the disclosure. While various embodiments may have been described as providing advantages or being preferred over other embodiments or prior art implementations with respect to one or more desired characteristics, as one skilled in the art is aware, one or more features or characteristics may be compromised to achieve desired overall system attributes, which depend on the specific application and implementation. These attributes include, but are not limited to: cost, durability, life cycle cost, marketability, packaging, size, serviceability, etc. The embodiments discussed herein that are described as less desirable than other embodiments or prior art implementations with respect to one or more characteristics are not outside the scope of the disclosure and may be desirable for particular applications or implementations.

What is claimed is:

1. A method for managing distribution of streaming video from a video server over a cellular network to a hand-held device, the method comprising:
capturing video from at least one camera in communication with the video server in response to a request from the hand-held device for video;
compressing and encoding the video captured from the at least one camera using the video server in communication with the at least one camera in response to the request from the hand-held device;
communicating the streaming video to the hand-held device;
dynamically changing at least one of the compressing and encoding to reduce bandwidth of streaming video in response to a change in network bandwidth; and
periodically reporting status of the video server to a management server in communication with the video server over a network.

2. The method of claim 1 wherein compressing and encoding comprises:
transforming output from the at least one camera to a first color palette;
adjusting each of a plurality of image properties until a captured video frame data size is below a first threshold;
converting the captured video frame data to a bitmapped image format using a lossless compression algorithm to generate a first compressed frame in a format native to the hand-held device;
compressing the first compressed frame using at least a second lossless compression algorithm to generate a compressed packet for transmission; and
transmitting the compressed packet over a wireless network to the hand-held device for display on the hand-held device.

3. The method of claim 1 further comprising:
distributing a video streaming application from the management server in response to a corresponding request from the mobile device.

4. The method of claim 3 further comprising:
determining that the hand-held device is authorized based on determining that an identification code embedded in the device is an authorized identification code.

5. The method of claim 1 further comprising:
configuring the video server to recognize a mobile device using the management server to communicate mobile device identification information to the video server.

6. The method of claim 5 wherein the management server communicates with the video server using the internet.

7. The method of claim 1 wherein compressing and encoding comprises converting an input video stream to an output video stream conforming to an MPEG standard.

8. The method of claim 1 further comprising controlling streaming video from the hand-held device by communicating a real-time streaming protocol (RTSP) request from the hand-held device to the video server.

9. The method of claim 1 further comprising communicating a request associated with a change in required bandwidth from the hand-held device to the video server; and
dynamically changing at least one of the compressing and encoding in response to the request.

10. The method of claim 3 wherein the application is distributed from the management server to the video server to the hand-held mobile device.

11. A system for managing distribution of streaming video from a video server over a cellular network to a hand-held device, the system comprising:
at least one camera;
a video server in communication with the at least one camera, the video server capturing video from the at least one camera, compressing and encoding the captured video, and dynamically changing at least one of the compressing and encoding to reduce bandwidth of streaming video in response to a corresponding command, the video server broadcasting the video to the hand-held device in response to an authenticated request from the hand-held device; and
a management server in communication with the video server, the management server including at least one hand-held device video client application program and distributing the client application program to the hand-held device in response to a corresponding request, the management server periodically receiving status information from the video server.

12. The system of claim 11 wherein the video server adjusts each of a plurality of image properties until a captured video frame data size is below a first threshold to reduce bandwidth of streaming video.

13. The system of claim 11 wherein the video server communicates with the management server over the internet.

14. The system of claim 11 wherein the video server broadcasts video to the hand-held device via a cellular network.

15. The system of claim 11 wherein the management server includes a configuration utility for configuring the video server to recognize a designated hand-held device.

16. The system of claim 11 wherein the video server includes a video capture card connected to the at least one camera and wherein dynamically changing comprises converting the captured video frame data to a bitmapped image format using a lossless compression algorithm to generate a first compressed frame in a format native to the hand-held device; and
compressing the first compressed frame using at least a second lossless compression algorithm to generate a compressed packet for transmission.

17. A method for managing distribution of video from a video server over a cellular network to a hand-held device, the method comprising:
configuring a distribution server with a hand-held client application and identification information for a selected hand-held device;
transferring the client application to the hand-held device;
configuring a video server in communication with at least one camera and in selective communication with the distribution server to recognize the hand-held device;
receiving a request from the hand-held device for the video server to transmit a selected video stream over the cellular network to the hand-held device;
determining that the hand-held device is authorized to receive a requested video stream;
capturing, compressing, and encoding video from the at least one camera in communication with the video server in response to a request from the hand-held device if the hand-held device is determined to be authorized;
transmitting compressed encoded video to the hand-held device if the hand-held device is determined to be authorized; and
dynamically managing bandwidth of video transmitted to the hand-held device by selectively modifying at least one of the compressing and encoding of the view from the at least one camera based on available cellular network bandwidth.

18. The method of claim 17 further comprising controlling video streaming functions from the hand-held device.

19. The method of claim 18 wherein controlling video streaming functions comprises transmitting an RTSP command from the hand-held device to the video server.

20. The method of claim 17 further comprising periodically communicating video server status information to a management server in communication with the video server via the internet.

21. The method of claim 17 further comprising selecting one of a plurality of cameras to receive streaming video using the hand-held device by communication a corresponding command to the video server.
